(19) United States
(12) Patent Application Publication
(10) Pub. No.: US 2006/0095714 A1
(43) Pub. Date: May 4, 2006

(54) Clip instruction for processor

(75) Inventors: Darrell D. Boggs, Aloha, OR (US); Christopher S. Jones, Portland, OR (US); Gary L. Brown, Aloha, OR (US)

Correspondence Address: Richard Calderwood;Stexar Corp., 20400 NW Amberwood Dr. #100, Beaverton, OR, 97006-7099, US

(73) Assignee: Stexar Corporation

(21) Appl. No.: 10/982,662

(22) Filed: Nov. 3, 2004

(51) Int. Cl. G06F 15/00

(52) U.S. Cl. 712/22

(57) ABSTRACT

A processor ISA instruction which performs a clipping operation forcing a data element to be within a specified range. A SIMD processor ISA instruction which performs a clipping operation upon each data element in a source operand vector.

### BACKGROUND OF THE INVENTION

1. Technical Field of the Invention

This invention relates generally to ISA-level processor instructions such as for a digital signal processor or a microprocessor, and more particularly to an instruction which performs clipping, picking, rounding, and packing of data elements in a single operation.

2. Background Art

Each microprocessor is designed to execute a set of architecture-level instructions, which require the presence of certain architecturally-visible registers and other hardware. The instructions, registers, and other hardware are often collectively referred to as the instruction set architecture (ISA) of the microprocessor.

Regardless of the particular ISA and any particular assembly language incarnation of that ISA, it is common practice in the art to generically describe any instruction in the following form:
OP (DEST, SRC1, SRC2)
   where “OP” is the opcode or the operation which the instruction performs, “DEST” is the destination where the result of the operation is to be stored, and “SRC1” and “SRC2” are the sources of the data upon which the operation is to be performed. This generic nomenclature will be used throughout this patent, and the reader should appreciate that no particular ISA is implied thereby. Many instructions permit the same register to be used as one or both of the operands, and/or as the destination.

Below the ISA level, a microprocessor may utilize a set of microarchitectural features, microcode, registers, execution units, data paths, and so forth, which are not architecturally visible. That is, their presence, absence, or configuration cannot be discerned by ISA code.

Below the microarchitectural level, a microprocessor may utilize circuits, logic, transistors, and so forth, of which the microarchitecture is independent.

A wide variety of ISA instructions are known in the art, such as ADD, SUBTRACT, MULTIPLY, DIVIDE, MOVE, LOAD, STORE, XOR, and so forth.

Some ISAs have provided a MIN instruction which returns the smaller of its (typically two) operands, and a MAX instruction which returns the larger of its operands. For example, the instruction
MAX (R1, R2, 52)
   copies the contents of source register R2 into destination register R1, unless R2 contains a value which is smaller than the specified constant 52, in which case the value 52 will be copied into register R1. Similarly, the instruction
MIN (MEM[5002], R3, 901)
   copies the contents of source register R3 into the memory location at address 5002, unless R3 contains a value larger than the specified constant 901, in which case the value 901 will be copied into that memory location.

In previous ISAs, if it was algorithmically necessary to force a result to be within a specified range—in other words, between a specified minimum and a specified maximum—it was necessary to perform a multi-instruction sequence such as
MAX (R1, R2, 25)
MIN (R3, R1, 200)

This puts into the destination register R3 the contents of source register R2, bounded by the specified range of 25 to 200.

Some ISAs have provided the ability to, with a single instruction, perform a same operation upon multiple source and destination data. These are commonly known as single-instruction multiple-data (SIMD) instructions, and they are said to operate on vector operands. Instructions which operate only on scalar operands could be termed single-instruction single-data (SISD) instructions, but they are more commonly referred to simply as scalar instructions.

For example, the scalar code sequence
ADD (R1[byte0], R2[byte0], R3[byte0])
ADD (R1[byte1], R2[byte1], R3[byte1])
ADD (R1[byte2], R2[byte2], R3[byte2])
ADD (R1[byte3], R2[byte3], R3[byte3])
   can be performed by a single SIMD instruction (which is defined by the ISA as operating byte-wise on each of the four bytes of each operand)
SADD (R1, R2, R3)

Some ISAs have provided an EXTRACT instruction, which returns as its result a specified subset or smaller portion of a source register. The subset can be specified by a general purpose register, or a control register, or an immediate value, or it can be implicitly specified by the opcode or other instruction information. For example, the instruction
EXTRACT (R1, R2, 1)
   copies byte 1 (as specified by the third operand, which is the immediate value 1) of the source register R2 into the destination register R1. This example extracts byte-sized data; other instructions may be configured to extract e.g. word-sized data. The size can be specified either explicitly as an immediate, or implicitly via the opcode, for example,
EXTRACT.WORD (R1, R2)

Some SIMD ISAs have provided PACK and UNPACK instructions, which are used to switch data between various widths. For example, the instruction
PACK.BYTE (R1, R2, R3)
   copies the even-numbered bytes from source register R2 into the high-order bytes of destination register R1, and the even-numbered bytes from source register R3 into the low-order bytes of destination register R1. The odd-numbered bytes (which are the high-order bytes of each respective two-byte word within the source registers) are discarded. After packing, the single register R1 holds the same data which previously occupied two registers R2 and R3 (assuming that the high-order bytes were not necessary).

Some ISAs have provided various forms of rounding instructions. Rounding operations are generally of one of four types: “up” (also called “ceiling”) which rounds toward positive infinity, “down” (also called “floor”) which rounds toward negative infinity, “zero” (also called “truncate” or “chop”) which rounds toward zero, and “closest” (also called “nearest”) which rounds toward the nearest whole number. For example, the instruction
ROUND (R1, R2, MODE_ZERO)
   rounds the value in source register R2 toward zero (as specified by the immediate constant MODE_ZERO), and stores the result in destination register R1.

While these various instructions are known in the art, what has not previously been known, and what would be extremely useful, is a single instruction which combines various features from several of those instructions.

### BRIEF DESCRIPTION OF THE DRAWINGS

FIG. 1 shows a logical data flow of a SIMD CLIP instruction according to one embodiment of the present invention.

FIG. 2 shows a logical data flow of a SIMD CLIP instruction according to another embodiment of this invention.

FIG. 3 shows a logical data flow of a SIMD CLIP AND PACK instruction according to yet another embodiment of this invention.

FIG. 4 shows a logical data flow of one element within a SIMD CLIP PICK AND PACK instruction according to still another embodiment of this invention.

FIG. 5 shows a block diagram of a microprocessor adapted to perform these instructions, according to one embodiment of this invention.

FIG. 6 shows a block diagram of one embodiment of a clip-and-pack unit such as may be used in the microprocessor of FIG. 5.

FIG. 7 shows a block diagram of one embodiment of a processor adapted to execute a SIMD clip-and-pack instruction.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only. While the invention will be described with reference to its embodiment as or within a microprocessor, the invention may be practiced in any other form of processor.

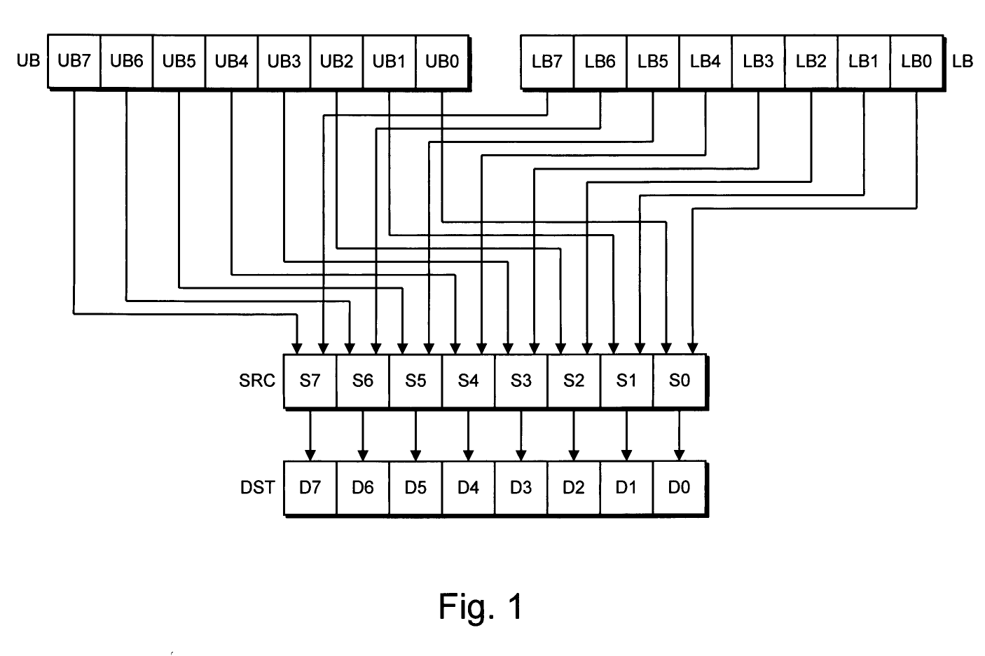

FIG. 1 illustrates a logical data flow of a SCLIP (SIMD CLIP) instruction according to one embodiment of this invention. The SCLIP instruction performs a MIN operation and a MAX operation simultaneously, to reduce code size and improve performance. A lower bound register LB specifies the minimum value and an upper bound register UB specifies the maximum value of a range within which the result is forced to be. The vector values S_{7:0} in the source register SRC are each forced within the specified range, and the resulting vector value D_{7:0} is written to the destination register DST.

In one embodiment, a single, same lower bound and a single, same upper bound are applied to each of the vector values. In another embodiment—that shown—the LB and UB registers, themselves, contain vector values LB_{7:0} and UB_{7:0}, respectively, permitting different clipping ranges to be applied to each of the source vector positions.

In some embodiments, the MIN operation is logically performed before the MAX operation, while in other embodiments the logical ordering is reversed.

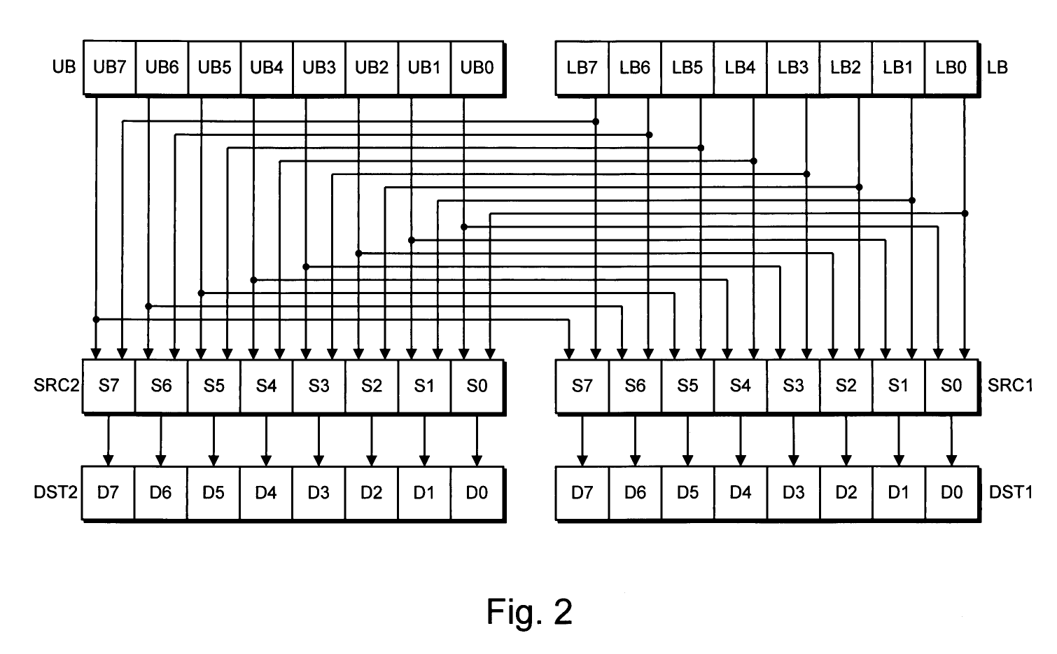

FIG. 2 illustrates a logical data flow of an SCLIP (SIMD CLIP) instruction which applies the clipping bounds LB and UB simultaneously to two source registers SRC1 and SRC2 to produce two results which are written to two respective destination registers DST1 and DST2. Another way of looking at this embodiment is that the clipping range registers LB and UB do not necessarily have to be of the same SIMD width as the source and/or destination registers, but can be repeated or strided in their application.

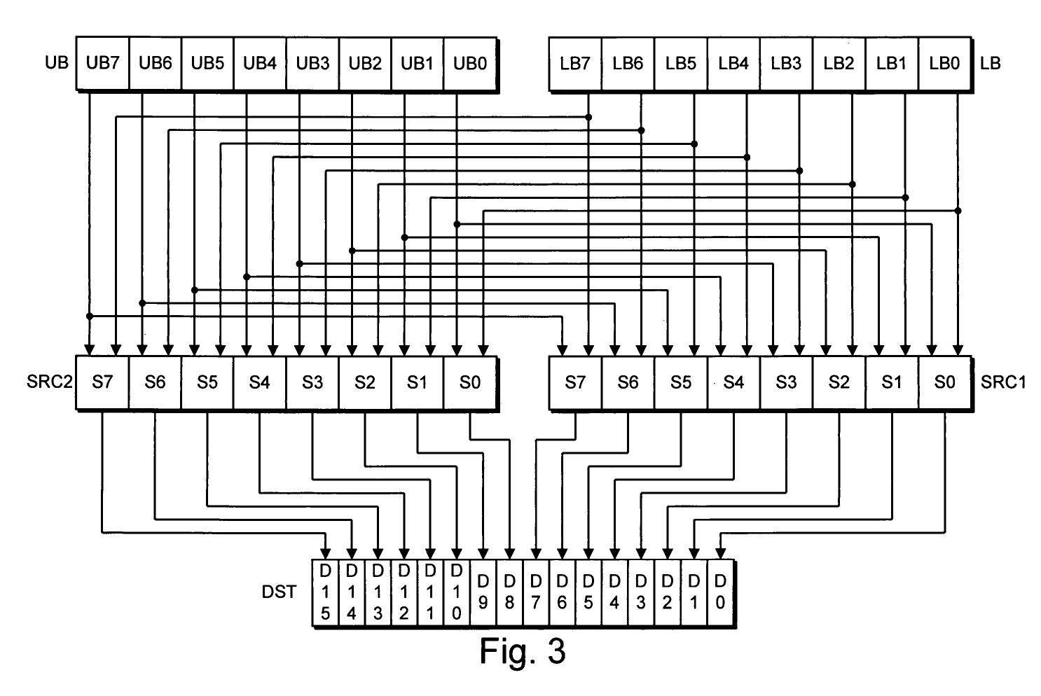

FIG. 3 illustrates a logical data flow of an SCLIPACK (SIMD CLIP AND PACK) instruction which applies the clipping bounds LB and UB simultaneously to two source registers SRC1 and SRC2 to produce two results which are packed into a single destination register DST. The destination register contains twice as many data elements as either source register, but its data elements are only half as wide as the data elements in the source registers.

In one embodiment, the clipped SIMD values from SRC2 are packed into the high-order half of DST, and the clipped SIME values from SRC1 are packed into the low-order half of DST. In another embodiment, the clipped SIMD values from the two source registers could be interleaved into the destination register. This interleaving is often referred to as a “shuffle” operation.

In some embodiments, a single register can hold the UB and LB values, for example UB in the upper (most significant) half of the register and LB in the lower (least significant) half of the register. This can be true whether the UB and LB are specified as scalar data (a single set of bounds applied to all data elements of a vector source) or as vector data. The UB and LB do not necessarily have to be the same width (in bits) as the source.

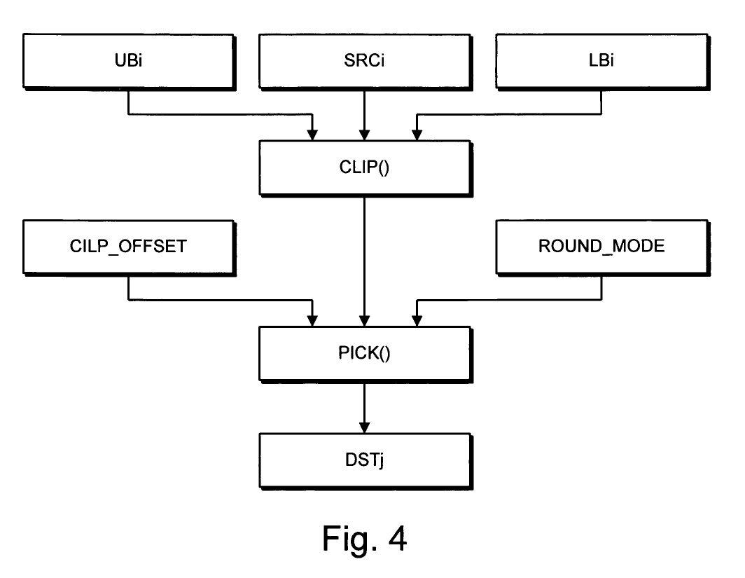

FIG. 4 illustrates a functional flow of one embodiment of an SCLIPACK instruction such as that of FIG. 3. FIG. 4 illustrates the operation as performed upon only a single data element (in the i^{th} position); operation upon the other data elements can be identical or substantially similar.

A clipping operation CLIP( ) is performed upon the source data element SRCᵢ, forcing the result to be between a lower bound LBᵢ and an upper bound UBᵢ. The result is wider than the destination data element location DSTⱼ so it is made narrower by a bit extraction operation PICK( ) which could also be termed a GETBITS( ) operation, then packed into the destination. (Where j is either the i^{th} position or the N+i^{th} position of DST, and N is the number of elements in SRC. For example, in the context of FIG. 3, if i is 3, then source element S3 from either SRC1 or SRC2 is being clipped by LB3 and UB3, and the result is being packed into DST at either D3 or D11.)

In some embodiments, a predetermined set of bits is selected from the clipped source data value for packing into the destination register. For example, it might always use the low-order bits, or it might always use the high-order bits. In other embodiments, the set of bits is dynamically selected according to a pick offset control register value PICK_OFFSET. For example, if the pick offset value is 2, the PICK( ) operation may operate upon clipped bits 9:2 of the clipped source value.

In some embodiments, rounding is performed on the result data prior to the packing operation, rather than simply truncating the result data and discarding bits; in some such embodiments, a rounding mode control register value ROUND_MODE specifies a rounding mode (such as ceiling, floor, zero, or nearest).

In some embodiments, the ROUND_MODE and/or PICK_OFFSET may be specified as parameters in the instruction, rather than in control registers or implicit registers. Alternatively, they can be specified by some combination of instruction bits such as part of the opcode or the immediate data.

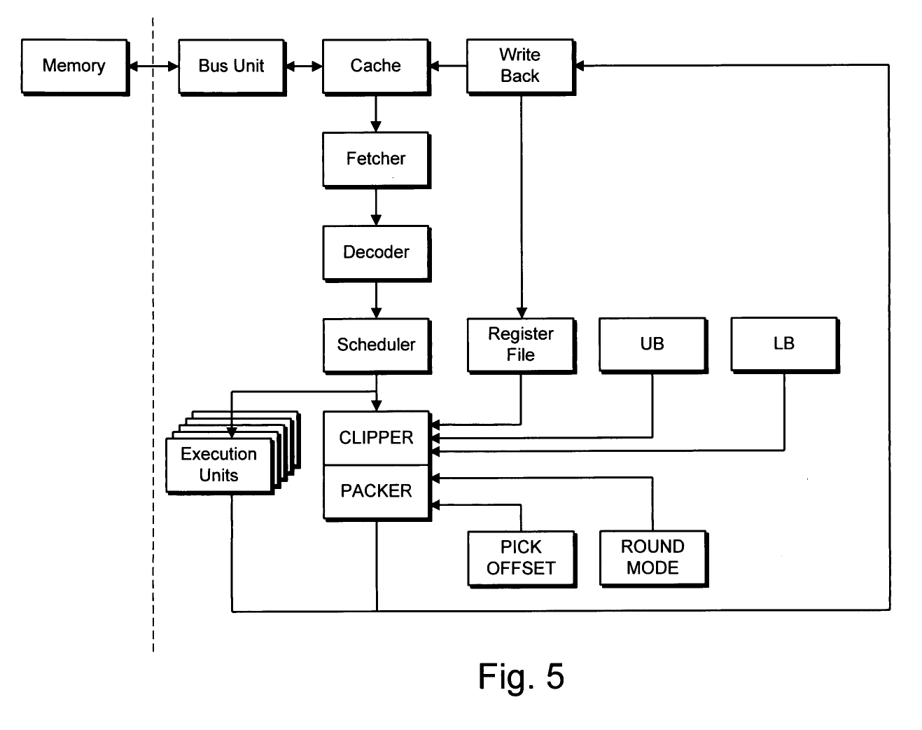

FIG. 5 illustrates a block diagram of a processor system utilizing this invention. The system includes a processor coupled to a memory; the dashed line indicates the chip or other such boundary of the processor. The processor includes a bus unit which interfaces a cache memory to the external memory over a bus. A fetcher brings in instructions and data from the cache memory (or from the external memory if they are not in the cache). A decoder decodes the instructions to determine what they are, and a scheduler sends the decoded instructions to one or more instruction execution units when the appropriate execution units are available and when the requisite data operands are available. When the decoder identifies that an instruction is one of the available varieties of clip-and-pack instructions, the scheduler steers that instruction to the clipper, which performs the clipping operation as described above, using data operands including a source which can come from a general purpose register in the register file, or from immediate data, or from memory, or any other suitable source, and including upper and lower bound values from the bounds registers UB and LB or other suitable sources. The clipper includes an associated packer which performs the packing/picking operation as described above, including pick offsetting and rounding. The result is written back to the destination, which may be a general purpose register, or memory, and so forth.

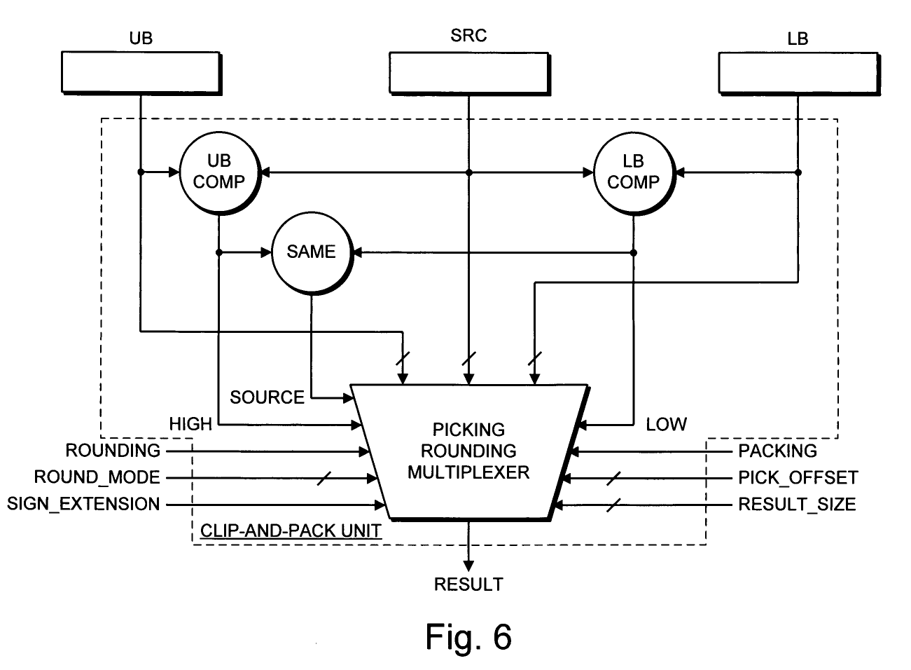

FIG. 6 illustrates a block diagram of one embodiment of a single data element's slice of a clip-and-pack unit such as may used in practicing the invention in a microprocessor. As the invention is practiced in a SIMD processor, the processor will include a plurality of such clip-and-pack units, one for each SIMD data slice. In some embodiments, the multiple clip-and-pack units may of course be grouped together as a SIMD clip-and-pack unit. For simplicity, only a single, scalar slice is shown.

The clip-and-pack unit receives as inputs the upper bound value UB, the lower bound value LB, and the source data SRC to be clipped. An upper bound comparator UB COMP compares the source data to the upper bound value, and generates a HIGH mux selection input to a picking rounding multiplexer (PRMux). A lower bound comparator LB COMP compares the source data to the lower bound value, and generates a LOW mux selection input to the PRMux. SAME logic (such as an XNOR gate) determines whether the outputs of the bound comparators are equal, and generates a SOURCE mux selection input to the PRMux.

If the SRC value is greater than the UB value, the HIGH input will be active and the PRMux will select (clip to) the UB value for processing as its result output. If the SRC value is less than the LB value, the LOW input will be active and the PRMux will select (clip to) the LB value for processing as its result output. If the SRC value is greater than the LB value and less than the UB value, the SOURCE mux input will be active and the PRMux will select the SRC value for processing as its result output.

In cases where the SRC value is equal to the LB value or the UB value, it does not matter whether the PRMux uses the SRC value or the LB/UB value, and the designer can implement the logic to use whichever input he chooses.

There is an unusual case where, due to a software programming error or other reason, the LB value is actually larger than the UB value. In this case, both the LOW and HIGH mux selection inputs will be active, and the SOURCE mux selection input will also be active. In one embodiment, the PRMux gives priority to the SOURCE mux selection input over the LOW and HIGH inputs, so the SRC value is not clipped. The SOURCE input is active when the SRC value is between the LB and UB values, regardless of whether the LB value is lower than or higher than the UB value.

In the case where the LB value is greater than the UB value, and the SRC value is greater than them both, only the HIGH input will be active (because the SRC value is greater than the UB value), which will cause the PRMux to select the UB value, which is actually the smaller of the two bounds values. If the UB value is less than the LB value, and the SRC value is less than them both, the LOW input will be active, causing the PRMux to select the LB value. Thus, if the bounds values are specified backward, and the SRC value is outside the incorrectly-specified range, the PRMux will clip to the opposite bound—if SRC is greater than both bounds, it will clip to UB (which is smaller than LB), and if SRC is smaller than both bounds, it will clip to LB (which is larger than UB).

In other embodiments, the clip-and-pack unit could treat the “LB greater than UB” situation as specifying a “clipping anti-range”, and the SRC value is clipped to be outside the specified anti-range. By “anti-range” it is meant that LB and UB specify a range from which the result is to be clipped so as to be outside the range, whereas clipping to a conventional range causes the result to be clipped so as to be inside the range. A properly ordered LB and UB thus specify a bandpass filter, and a reverse ordered LB and UB specify a notch filter.

In some embodiments, the processor could generate an exception informing the system that the LB is greater than the UB. In some such embodiments, the exception could be treated as an error condition.

In some embodiments, the processor could internally, silently compensate for the reversal of the LB and UB values, and generate the same results which would have been generated if the LB and UB had been in the correct order. In some such embodiments, it may do so without actually swapping the storage locations of the UB and LB values; that is, the stored LB will still be greater than the stored UB.

In some embodiments, a PACKING enable signal controls whether the PRMux performs packing. If the PACKING signal is active, the PRMux selects a subset of the clipped value, as described above. If the PACKING signal is inactive, the entire clipped value is passed through. In some embodiments, a RESULT_SIZE input specifies (either directly or via some implicit or explicit encoding) the number of bits to be output as the result value, enabling different degrees of packing to be achieved. In other embodiments, a single packing factor is used, and the RESULT_SIZE input is not necessary. For example, the PRMux may always reduce a 16-bit clipped value to an 8-bit packed value.

In some embodiments, a ROUNDING enable signal controls whether the PRMux performs rounding of the clipped value before providing it as the result output. In some embodiments, a ROUND_MODE input value specifies the rounding mode, such as specifying “floor”, “ceiling”, “zero”, or “nearest” rounding. In some embodiments, there is only a single rounding mode, and the ROUND_MODE input value is not necessary, with the ROUNDING enable signal selecting between e.g. no rounding and a predetermined rounding scheme, or between two predetermined rounding schemes.

In some embodiments, an PICK_OFFSET determines the position from which the PRMux selects the bits for packing and/or rounding. For example, an PICK_OFFSET value of 2 may cause the PRMux to discard bit positions 0 and 1 from the clipped value, and to provide e.g. bits 2 through 9 as an 8-bit result. In some embodiments, it is the discarded bits which are used in determining the rounding of the result.

Rounding, packing, and picking may be used in any combination.

In some embodiments, a SIGN_EXTENSION input determines whether the result value should be sign extended or zero extended, as determined by how the programmer has specified the instruction. The sign extension happens based on the control. The sign bit that is used to extend is the MSB of the pre-extracted value. If the range does not extend to the left past the MSB of the element, then sign extension will have no affect.

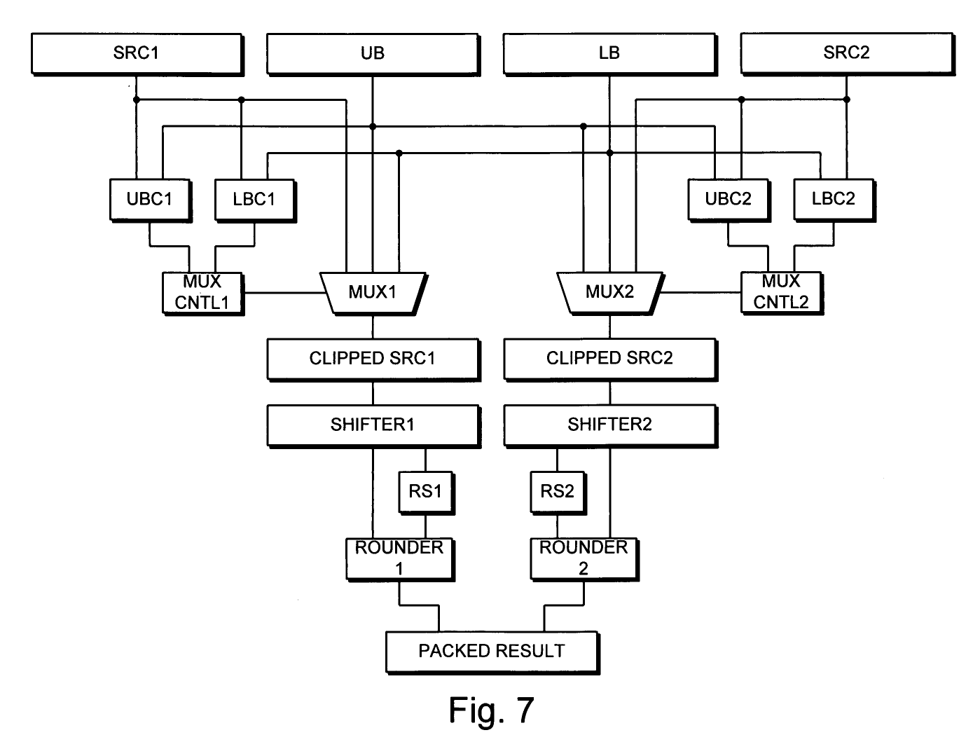

FIG. 7 illustrates, in block diagram fashion, one embodiment of a processor adapted for executing a SIMD clip-and-pack instruction such as described above. The processor includes storage for holding a first N-element source operand SRC1 and a second N-element source operand SRC2. N may be any positive integer (typically but not necessarily one which is a power of 2), and may be fixed or dynamically determined, depending upon the needs of the application at hand. In one embodiment, N=8 and each source operand may be e.g. a 128-bit register holding N=8 16-bit values. The processor further includes storage for holding an M-element upper clipping bound value UB and an M-element lower clipping bound value LB, each of which may be either a scalar value or e.g. a 128-bit register holding M=8 16-bit values, where M may be any positive integer and may be fixed or dynamically determined. In some embodiments, M=N. In other embodiments, M=1 such that all N elements are clipped to the same range of values. In other embodiments, M>1 and M< >N; for example, N=8 and M=4, such that each source operand register holds two different 4-element tuples (e.g. Red, Green, Blue, and Alpha channel data elements) and the upper and lower bound registers each holds one 4-element tuple which is applied to the source in a strided manner (that is, each 4-tuple in the source operand is clipped to the same 4-tuple bounds).

The processor includes a first upper bound comparator UBC1 coupled to receive the first source operand and the upper bound value, and a first lower bound comparator LBC1 coupled to receive the first source operand and the lower bound value. The processor further includes a first multiplexer control unit MUX CNTL1 which is coupled to receive the outputs of the first upper and lower bound comparators. The processor also includes a first multiplexer MUX1 which is coupled to receive the first source operand, the upper bound value, and the lower bound value, and which is further coupled to receive control signals from the first multiplexer control unit. The first multiplexer passes one of the first source operand, the lower bound, and the upper bound, as determined by the first multiplexer control unit. The passed value is a first clipped source operand CLIPPED SRC1.

The processor includes a second upper bound comparator UBC2 coupled to receive the second source operand and the upper bound value, and a second lower bound comparator LBC2 coupled to receive the second source operand and the lower bound value. The processor also includes a second multiplexer control unit MUX CNTL2 which is coupled to receive the outputs of the second upper and lower bound comparators, and a second multiplexer MUX2 which is coupled to receive the second source operand, the upper bound value, and the lower bound value, and to pass one of them as determined by the second multiplexer control unit. The passed value is a second clipped source operand CLIPPED SRC2.

The processor includes a first shifter SHIFTER1 which is coupled to receive the first clipped source operand and a second shifter SHIFTER2 which is coupled to receive the second clipped source operand. The first shifter performs a pick (by right shifting) of each of the N elements in the first clipped source operand, and generates N round-bit and sticky-bit pairs RS1. The second shifter performs a pick (by right shifting) of each of the N elements in the second clipped source operand, and generates N round-bit and sticky-bit pairs RS2. In one embodiment, each shifter receives an N-element input containing N X-bit data elements, and generates an N-element output containing N X/Y-bit data elements, where Y is any positive integer. In one such embodiment, Y=2; for example, each shifter receives a 128-bit input containing 8 16-bit clipped values, and generates a 64-bit output containing 8 8-bit clipped values. In some embodiments, Y is fixed, while in other embodiments, Y can be dynamically determined by control inputs (not shown). It should be noted that the shifters do not shift bits across separate data elements within their inputs; that is, least significant bits from e.g. element 3 do not get shifted into the most significant bit positions of e.g. element 2. Rather, the shifting is independent as between the various data elements.

The processor includes a first rounder ROUNDER1 which is coupled to receive the N-element picked output and the round-bit and source-bit pairs RS1 from the first shifter, and a second rounder ROUNDER2 which is coupled to receive the N-element picked output and the round-bit and source-bit pairs RS2 from the second shifter.

Each rounder separately rounds each element of its respective N-element input. In some embodiments, the rounding mode is fixed (e.g. it is always “round to nearest even”), while in other embodiments, the rounding mode is dynamically determined by control inputs (not shown). The round-bit and sticky-bit values and the rounding operations may be substantially as known in the art.

The X/Y-bit rounded N-element output of the first rounder and the X/Y-bit rounded N-element output of the second rounder are concatenated into an X-bit YN-element packed result register PACKED RESULT or other suitable result storage or data path location.

The reader should note that, in the example shown, Y=2, such that 2 source operands are clipped and packed into the packed result register. In other embodiments, where Y>2, there will be more than two source operands and a corresponding set of data path elements UBC_{Y}, LBC_{Y}, MUX CNTL_{Y}, MUX_{Y}, CLIPPED SRC_{Y}, SHIFTER_{Y}, RS_{Y}, and ROUNDER_{Y} for each additional source operands. For example, the processor may perform a 4:1 packing rather than the 2:1 packing illustrated.

### CONCLUSION

The term “processor” should be interpreted to mean any of: a single-chip microprocessor, a multi-chip processor module, a digital signal processor, a coprocessor, a computer, an embedded controller, an ASIC, a suitably programmed FPGA or other such reprogrammable logic array, or any other logic means which executes instructions, whether those instructions are ISA-level instructions, microcode, control logic code, or what have you.

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A SIMD digital signal processor comprising:
an operand register (SRC) which is NX bits wide for holding N X-bit data elements;
an upper bound register (UB);
a lower bound register (LB);
a data path including,
an upper bound comparator (UBC) coupled to compare contents of the operand register with contents of the upper bound register,
a lower bound comparator (LBC) coupled to compare contents of the operand register with contents of the lower bound register,
a multiplexer control unit (MUX CNTL) coupled to receive outputs of the upper bound comparator and the lower bound comparator and generate a multiplexer control value, and
a multiplexer (MUX) coupled to output one of the contents of the lower bound register, the contents of the upper bound register, and the operand register, in response to the multiplexer control value, whereby a clipped result is generated.

2. A processor comprising:
an instruction fetcher;
a register file; and
an execution unit coupled to the instruction fetcher and to the register file and responsive to a single-instruction clip instruction fetched by the instruction fetcher to clip a source operand to a range determined by an upper bound and a lower bound, thereby generating a clipped result; and
means for writing the clipped result into the register file.

3. The processor of claim 2 wherein:
the instruction expressly identifies the source operand.

4. The processor of claim 3 wherein:
the instruction expressly identifies the source operand as a register within the register file.

5. The processor of claim 2 wherein:
the instruction expressly identifies the upper bound and the lower bound.

6. The processor of claim 5 wherein:
the instruction expressly identifies the upper bound and the lower bound as at least one register within the register file.

7. The processor of claim 2 wherein:
the source operand comprises a vector; and
the clip instruction comprises a SIMD instruction.

8. The processor of claim 7 wherein:
the upper bound comprises a vector;
the lower bound comprises a vector; and
the clip instruction clips each element of the source operand vector to a respective range determined by corresponding elements of the upper bound vector and of the lower bound vector.

9. A SIMD processor comprising:
means for fetching instructions including a clip instruction;
means for executing the fetched instructions, including,
means for executing the clip instruction and thereby, in a single instruction, clipping each data element in a specified source data vector to a range indicated by a specified upper bound value and a specified lower bound value, to generate a clipped result data vector.

10. The SIMD processor of claim 9 wherein:
a separate upper bound value and a separate lower bound value are specified for each of the data elements in the specified source data vector.

11. A method whereby a SIMD processor executes a single-instruction clip instruction, the method comprising:
fetching the clip instruction;
decoding the fetched clip instruction;
scheduling the decoded clip instruction;
executing the scheduled clip instruction to, for each data element of a source data vector specified by the clip instruction, wherein executing the scheduled clip instruction includes,
clipping the data element to a range between a lower bound value and an upper bound value;
whereby the clip instruction clips a plurality of data elements in the source data vector to generate a clipped result data vector.

12. The method of claim 11 wherein:
the clip instruction specifies the source data vector.

13. The method of claim 12 wherein:
the clip instruction specifies the source data vector as a general purpose register.

14. The method of claim 11 wherein:
the clip instruction specifies the lower bound value and the upper bound value.

15. The method of claim 14 wherein:
the clip instruction specifies the lower bound value and the upper bound value as general purpose registers.

16. The method of claim 14 wherein:
the clip instruction specifies the lower bound value and the upper bound value as immediate data.

17. The method of claim 11 wherein:
the lower bound value and the upper bound value are contained in dedicated clipping range boundary registers.

18. The method of claim 11 wherein:
the upper bound is specified as a first value;
the lower bound is specified as a second value; and
if the first value is less than the second value, clipping the data element to the range includes,
clipping the data element to an anti-range specified by the first and second values.

19. The method of claim 11 wherein:
the upper bound is specified as a first value;
the lower bound is specified as a second value; and
if the first value is less than the second value, executing the scheduled clip instruction further includes,
logically swapping the first and second values, to specify the range.

20. A microprocessor comprising:
an instruction fetcher for fetching ISA instructions including SIME instructions and a single-instruction clip instruction;
an instruction decoder for decoding the fetched ISA instructions into native instructions;
a plurality of execution units for executing the native instructions, including,
a clip unit for executing native instruction(s) into which the clip instruction has been decoded, to clip a source specified by the clip instruction to a range between an upper bound value and a lower bound value to generate a clipped result value.

21. The microprocessor of claim 20 wherein:
the upper bound value and the lower bound value are specified by the clip instruction.

22. The microprocessor of claim 21 wherein:
the clip instruction comprises a SIMD instruction;
the source specified by the clip instruction comprises a source data vector having a plurality of data elements; and
the clip unit clips each of the plurality of data elements of the source data vector to generate a clipped result data vector as the clipped result value.

23. An improvement in a SIMD microprocessor, the microprocessor including execution units for executing SIMD ISA instructions, wherein the improvement comprises:
means, in the execution units, responsive to a single-instruction SIMD clip ISA instruction, for clipping each data element of a source data vector specified by the SIMD clip ISA instruction to a specified range.
